(19) United States
(12) Patent Application Publication
(10) Pub. No.: US 2016/0249610 A1
(43) Pub. Date: Sep. 1, 2016

(54) NON-CONDUCTIVE ANTIBACTERIAL SHEET, METHOD FOR MANUFACTURING THEREOF, AND ANTIBACTERIAL METHOD

(71) Applicant: THINK LABORATORY CO., LTD., Chiba (JP)

(72) Inventors: Tatsuo Shigeta, Kashiwa-shi, Chiba (JP); Kazuei Igarashi, Chiba-shi, Chiba (JP); Kaku Shigeta, Kashiwa-shi, Chiba (JP)

(21) Appl. No.: 15/033,050

(22) PCT Filed: Nov. 4, 2014
(86) PCT No.: PCT/JP2014/079180

§ 371 Date: Apr. 28, 2016

(30) Foreign Application Priority Data
Nov. 12, 2013 (JP) 2013-234219
Mar. 14, 2014 (JP) 2014-051320

(51) Int. Cl. A01N 25/34; B29C 59/04; B29C 35/08; B29C 41/26

(52) U.S. Cl. CPC A01N 25/34; B29C 41/26; B29C 59/046; B29C 35/0805; B29C 2035/0827; B29K 2033/08

(57) ABSTRACT

Provided are a non-conductive antibacterial sheet, a method for manufacturing thereof, and an antibacterial method, wherein it is enough that the feature height of the non-conductive antibacterial sheet is shallower than the conventional one, and hence many materials may be used for preparation thereof. The non-conductive antibacterial sheet of an acrylic resin comprises a micropatterned concave and convex surface in which there are produced concave and convex micropattern groups by forming multiple protrusion portions each having a nearly rectangular shape in a plane view on the surface thereof, wherein the protrusion portions are regularly formed in an x-direction and a y-direction orthogonal thereto with x-direction spaces and y-direction spaces, the both spaces having predetermined widths; a height from the surface of the sheet to the top of the protrusion portion is 0.4 μm to 1 μm; a bottom width of the protrusion portion is 2 μm to 3 μm, and the width of the x-direction space is equal to the bottom width of the protrusion portion; and the non-conductive antibacterial sheet exhibits an antibacterial effect in such a way that bacteria which are in static contact with the micropatterned surface are not trapped in the x-direction spaces.

### TECHNICAL FIELD

The present invention relates to a non-conductive antibacterial sheet comprising a micropatterned concave and convex surface of an acrylic resin in which there are produced concave and convex micropattern groups by forming on the surface of the sheet multiple protrusion portions or groove portions each having a nearly rectangular shape in a plane view. The present invention also relates to a method for manufacturing the non-conductive antibacterial sheet, and an antibacterial method using the non-conductive antibacterial sheet.

### BACKGROUND ART

In the field of medicine and environmental pollution, the efficient method to remove the contaminated bacteria is always searched. Bacteria growing on surfaces of materials such as catheter or drainage often form biofilms. The biofilms symbolize a complex bacterial lifestyle that provides protection from environmental stresses (Non-Patent Documents 1-4).

An estimated 80% of all bacterial infections are related to biofilms (Non-Patent Documents 5 and 6). Formation of the biofilms leads to increasingly getting out of hand, and further biofilms are able to effectively invade bio-defense system to interfere treatment (Non-Patent Documents 5 and 6).

It has been recently reported that a Sharklet (registered trademark) micropattern which resembles to the skin of sharks is effective in inhibiting biofilm formation and migration of Staphylococcus aureus and Escherichia coli (Non-Patent Documents 7 and 8).

The Sharklet (registered trademark) micropattern comprises a micropatterned surface with a micropatterned concave and convex surface wherein there are produced concave and convex micropattern groups by forming multiple protrusion portions or groove portions each having a nearly rectangular shape in a plane view on the surface thereof. The Sharklet (registered trademark) microtopography was designed at 2 μm feature width and spacing and 3 μm feature height, which would be slightly large to effectively reduce the attachment of the bacteria in the size range of approximately 1 to 2 μm but could be effective at physically disrupting further colonization of additional bacteria and subsequent biofilm formation. In the case of the Sharklet (registered trademark) micropattern, alive bacteria were located in the spacing thereof (Non-Patent Document 7). FIG. 6 is a cross-sectional schematic view illustrating a conventional conductive antibacterial sheet forming a micropattern. In FIG. 6, a protrusion portion 102 formed on a surface 104 of the sheet of the conductive antibacterial sheet 100 has a height L of 3 μm or more and a bottom width W of 2 μm, and a width S of the space 120 of the groove portion is 2 μm, and hence bacteria 24 are trapped in the spaces 120 of the groove portions.

The Sharklet (registered trademark) micropattern was made using silicone elastomer. If it would be enough that the feature height thereof is shallow (preferably less than 1 μm), many materials may be used for preparation of the shark skin micropattern.

### PRIOR ART DOCUMENTS

### Non-Patent Document

Non-Patent Document 1: Mah T F, Pitts B, Pellock B, Walker G C, Stewart P S, O'Toole G A. 2003. A genetic basis for Pseudomonas aeruginosa biofilm antibiotic resistance. Nature. 426:306-310.

Non-Patent Document 2: Hinsa S M, Espinosa-Urgel M, Ramos J L, O'Toole G A. 2003. Transition from reversible to irreversible attachment during biofilm formation by Pseudomonas fluorescens WCS365 requires an ABC transporter and a large secreted protein. Mol Microbiol. 49:905-918.

Non-Patent Document 3: Banin E, Vasil M L, Greenberg E P, 2005. Iron and Pseudomonas aeruginosa biofilm formation. Proc Natl Acad Sci USA. 102:11076-11081.

Non-Patent Document 4: Fux C A, Costerton J W, Stewart P S, Stoodley P. 2005. Survival strategies of infectious biofilms. Trends Microbiol. 13:34-40.

Non-Patent Document 5: Davies D. 2003. Understanding biofilm resistance to antibacterial agents. Nat Rev Drug Discov. 2:114-122.

Non-Patent Document 6: Lopez D, Vlamakis H, Kolter R. 2010. Biofilms. Cold Spring Harb Perspect Biol. 2:a000398.

Non-Patent Document 7: Chung K K, Schumacher J F, Sampson E M, Burne R A, Antonelli P J, Brennan A B. 2007. Impact of engineered surface microtopography on biofilm formation of Staphylococcus aureus. Biointerphases. 2:89-94.

Non-Patent Document 8: Reddy S T, Chung K K, McDaniel C J, Darouiche R O, Landman J, Brennan A B. 2011. micropatterned surfaces for reducing the risk of catheter-associated urinary tract infection: An in vitro study on the effect of Sharklet micropatterned surfaces to inhibit bacterial colonization and migration of uropathogenic Escherichia coli. J Endourol. 25:1547-1552.

Non-Patent Document 9: Vogel H J, Bonner D M. 1956. Acetylornithinase of Escherichia coli: partial purification and some properties. J Biol Chem. 218:97-106.

Non-Patent Document 10: Hassett D J, Schweizer H P, Ohman D E. 1995. Pseudomonas aeruginosa sodA and sodB mutants defective in manganese- and iron-cofactored superoxide dismutase activity demonstrate the importance of the iron-cofactored form in aerobic metabolism. J Bacteriol. 177:6330-6337.

Non-Patent Document 11: Sakamoto A, Terui Y, Yamamoto T, Kasahara T, Nakamura M, Tomitori H, Yamamoto K, Ishihama A, Michael A J, Igarashi K, Kashiwagi K. 2012. Enhanced biofilm formation and/or cell viability by polyamines through stimulation of response regulators UvrY and CpxR in the two-component signal transducing systems, and ribosome recycling factor. Int J Biochem Cell Biol. 44:1877-1886.

Non-Patent Document 12: de la Fuente-Nunez C, Korolik V, Bains M, Nguyen U, Breidenstein E B, Horsman S, Lewenza S, Burrows L, Hancock R E. 2012. Inhibition of bacterial biofilm formation and swarming motility by a small synthetic cationic peptide. Antimicrob Agents Chemother. 56:2696-2704.

Non-Patent Document 13: Lamppa J W, Griswold K E. 2013. Alginate lyase exhibits catalysis-independent biofilm dispersion and antibiotic synergy. Antimicrob Agents Chemother. 57:137-145.

Non-Patent Document 14: Long C J, Schumacher J F, Brennan A B. 2009. Potential for tunable static and dynamic contact angle anisotropy on gradient microscale patterned topographies. Langmuir. 25:12982-12989.

Non-Patent Document 15: Long C J, Schumacher J F, Robinson P A. 2nd. Finlay J A, Callow M E, Callow J A, Brennan A B. 2010. A model that predicts the attachment behavior of Ulva linza zoospores on surface topography. Biofouling. 26:411-419.

### SUMMARY OF THE INVENTION

### Problems to be Solved by the Invention

The present invention has been made in view of the above-mentioned problem inherent in the related art, and it is therefore an object thereof to provide a non-conductive antibacterial sheet, a method for manufacturing thereof, and an antibacterial method, wherein it is enough that the feature height of the non-conductive antibacterial sheet is shallower than the conventional one and hence many materials may be used for preparation thereof.

### Means for Solving Problems

In order to solve the above-mentioned problem, according to the first embodiment of the present invention, there is provided a non-conductive antibacterial sheet comprising a micropatterned concave and convex surface of an acrylic resin in which there are produced concave and convex micropattern groups by forming on the surface of the sheet multiple protrusion portions each having a nearly rectangular shape in a plane view, wherein the protrusion portions are regularly formed in an x-direction and a y-direction orthogonal thereto with x-direction spaces and y-direction spaces, the both spaces having predetermined widths; a height from the surface of the sheet to the top of the protrusion portion is 0.4 μm to 1 μm; a bottom width of the protrusion portion is 2 μm to 3 μm, and the width of the x-direction space is equal to the bottom width of the protrusion portion; and the non-conductive antibacterial sheet exhibits an antibacterial effect in such a way that bacteria which are in static contact with the micropatterned surface are not trapped in the x-direction spaces. The width of the y-direction space is preferably 3 to 8 μm.

In the present specification, the term “sheet” is used as a term broadly meaning sheet-like materials, including both of film-like materials and plate-like materials as long as they are non-conductive.

Thus the present inventors have found that if the height from the surface of the sheet to the top of the protrusion portion is 0.4 μm to 1 μm, the bottom width of the protrusion portion is 2 μm to 3 μm, and the width of the x-direction space is equal to the bottom width of the protrusion portion, the bacteria of about 3 μm in full-length do not trapped in the x-direction spaces, but the non-conductive antibacterial sheet exhibits an antibacterial effect without trapping of the bacteria in the x-direction spaces. That is, the non-conductive antibacterial sheet of the present invention exhibits antibacterial effect even when the feature height of the micropatterned surface with the micropatterned concave and convex surface is shallow.

According to the second embodiment of the present invention, there is provided a non-conductive antibacterial sheet comprising a micropatterned concave and convex surface of an acrylic resin in which there are produced concave and convex micropattern groups by forming on the surface of the sheet multiple groove portions each having a nearly rectangular shape in a plane view, wherein the groove portions are regularly formed in an x-direction and a y-direction orthogonal thereto with x-direction spaces and y-direction spaces, the both spaces having predetermined widths, a depth from the surface of the sheet to the bottom of the groove portion is 0.4 μm to 1 μm, an opening width of the groove portion is 2 μm to 3 μm, and the width of the x-direction space is equal to the opening width of the groove portion, and the non-conductive antibacterial sheet exhibits an antibacterial effect in such a way that bacteria which are in static contact with the micropatterned surface are not trapped in the groove portions. The width of the y-direction space is preferably 3 to 8 μm.

Thus the present inventors have found that if the groove portions are regularly formed in an x-direction and a y-direction orthogonal thereto with x-direction spaces and y-direction spaces, the both spaces having predetermined widths, a depth from the surface of the sheet to the bottom of the groove portion is 0.4 μm to 1 μm, an opening width of the groove portion is 2 μm to 3 μm, the bacteria of about 3 μm in full-length do not trapped in the groove portions, but the non-conductive antibacterial sheet exhibits antibacterial effect without trapping in the groove portions. That is, the non-conductive antibacterial sheet of the present invention exhibits antibacterial effect even when the feature height of the micropatterned surface with the micropatterned concave and convex surface is shallow.

Further, the acrylic resin is preferably polyacrylate.

The bacteria in moisture such as solution form biofilms. However, the non-conductive antibacterial sheet of the present invention inhibits biofilm formation of the bacteria which are in static contact with the micropatterned surface of the non-conductive antibacterial sheet.

Further, the non-conductive antibacterial sheet of the present invention inhibits swarming (chemotaxis) of the bacteria by covering the bacteria standing still on a surface with the non-conductive antibacterial sheet in such a way that the bacteria are in static contact with the micropatterned surface.

The surface on which the bacteria are allowed to stand still may be a surface of a filter. Even when the surface of the filter is used as the surface, swarming (chemotaxis) of the bacteria can be inhibited.

An antibacterial method of the present invention is characterized by using the non-conductive antibacterial sheet.

The antibacterial method of the present invention preferably inhibits biofilm formation of the bacteria by statically contacting the bacteria with the micropatterned surface of the non-conductive antibacterial sheet.

The antibacterial method of the present invention preferably inhibits swarming of bacteria by covering the bacteria standing on the surface with the non-conductive antibacterial sheet.

A method for manufacturing the non-conductive antibacterial sheet of the present invention is characterized in that the micropatterned surface of the non-conductive antibacterial sheet is produced by transferring an acrylic resin to a synthetic resin film with a patterning roll.

In the method for manufacturing the non-conductive antibacterial sheet of the present invention, it is preferably that the acrylic resin is an ultraviolet curable acrylic resin, and the acrylic resin transferred to the synthetic resin film is cured by ultraviolet curing.

A method for manufacturing the non-conductive antibacterial sheet of the present invention preferably comprises steps of: supplying an ultraviolet curable acrylic resin onto a micro patterned concave and convex surface of a patterning roll which is produced by forming multiple protrusion portions and/or groove portions each having a nearly rectangular shape in a plane view on the surface thereof; transferring the acrylic resin to a synthetic resin film by continuously conveying the synthetic resin film to the surface of the patterning roll so as to bring the film into contact with the surface of the roll; and irradiating the acrylic resin transferred to the synthetic resin film with ultraviolet rays to cure the acrylic resin.

### Advantageous Effects of the Invention

The present invention has a remarkable effect of providing a non-conductive antibacterial sheet, a method for manufacturing thereof, and an antibacterial method, wherein it is enough that the feature height of the non-conductive antibacterial sheet is shallower than the conventional one and hence many materials may be used for preparation thereof.

### BRIEF DESCRIPTION OF DRAWINGS

FIG. 1 is an enlarged partial perspective view illustrating one example according to the first embodiment of the non-conductive antibacterial sheet of the present invention.

FIG. 2 is an enlarged partial perspective view illustrating one example according to the second embodiment of the non-conductive antibacterial sheet of the present invention.

FIG. 3 is an enlarged partial perspective view illustrating another example according to the first embodiment of the non-conductive antibacterial sheet of the present invention.

FIG. 4 is an enlarged partial perspective view illustrating another example according to the second embodiment of the non-conductive antibacterial sheet of the present invention.

FIG. 5 is an enlarged cross-sectional schematic view illustrating the non-conductive antibacterial sheet of the present invention, FIG. 5(a) shows the first embodiment and FIG. 5(b) shows the second embodiment.

FIG. 6 is a cross-sectional schematic view illustrating a conventional conductive antibacterial sheet in which a micropattern is formed.

FIG. 7 is a schematic side view illustrating a state of inhibiting biofilm formation with the non-conductive antibacterial sheet of the present invention.

FIG. 8 is a schematic side view illustrating biofilm formation on a conventional flat and smooth non-conductive antibacterial sheet.

FIG. 9 is a schematic perspective view illustrating a state of inhibiting swarming of bacteria by covering the bacteria standing still on a surface with the non-conductive antibacterial sheet of the present invention.

FIG. 10 is a schematic side view illustrating an embodiment of an apparatus used in the method for manufacturing the non-conductive antibacterial sheet according to the present invention.

FIG. 11 is a graph showing a result of stirring culture of Pseudomonas aeruginosa in absorbance.

FIG. 12 is a graph showing a result of biofilm formation by a static biofilm assay in absorbance.

FIG. 13 is photographs showing a result of a swarming motility assay of Pseudomonas aeruginosa.

FIG. 14 is a graph showing a result of the swarming motility assay of Pseudomonas aeruginosa in relative width.

FIG. 15 is SEM photographs of plates used in the swarming motility assay of Pseudomonas aeruginosa, FIG. 15A is photographs showing a micropatterned surface of the plates, and FIG. 15B is photographs showing states thereof after the swarming motility assay was performed by using the plates.

### MODES FOR CARRYING OUT THE INVENTION

Embodiments of the present invention are described below, but those embodiments are described as examples, and hence it is understood that various modifications may be made thereto without departing from the technical spirit of the present invention.

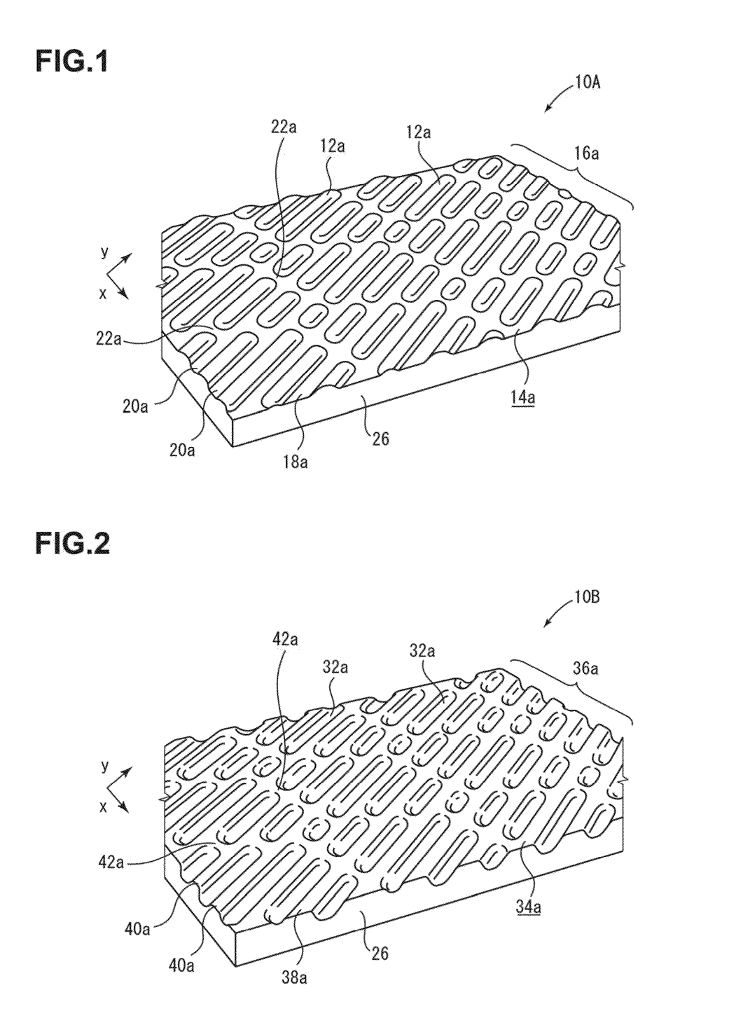

FIG. 1 shows one example according to the first embodiment of the non-conductive antibacterial sheet of the present invention. Referring to FIG. 1, reference symbol 10A represents one example according to the first embodiment of the non-conductive antibacterial sheet of the present invention. The non-conductive antibacterial sheet 10A comprises a micropatterned concave and convex surface 18a of an acrylic resin in which there are produced micropattern concave and convex groups 16a by forming multiple protrusion portions 12a on the surface 14a of the sheet each having a nearly rectangular shape in a plane view. The protrusion portions 12a are regularly formed in an x-direction and a y-direction orthogonal thereto with x-direction spaces 20a and y-direction spaces 22a, the both spaces having predetermined widths. As is well illustrated in FIG. 1, the x-direction space 20a is a space formed in the x-direction and the y-direction space 22a is a space formed in the y-direction.

Further, a height from the surface 14a of the sheet to the top of the protrusion portions 12a is 0.4 μm to 1 μm, a bottom width of the protrusion portions 12a is 2 μm to 3 μm, and the width of the x-direction space 20a is equal to the bottom width of the protrusion portion 12a.

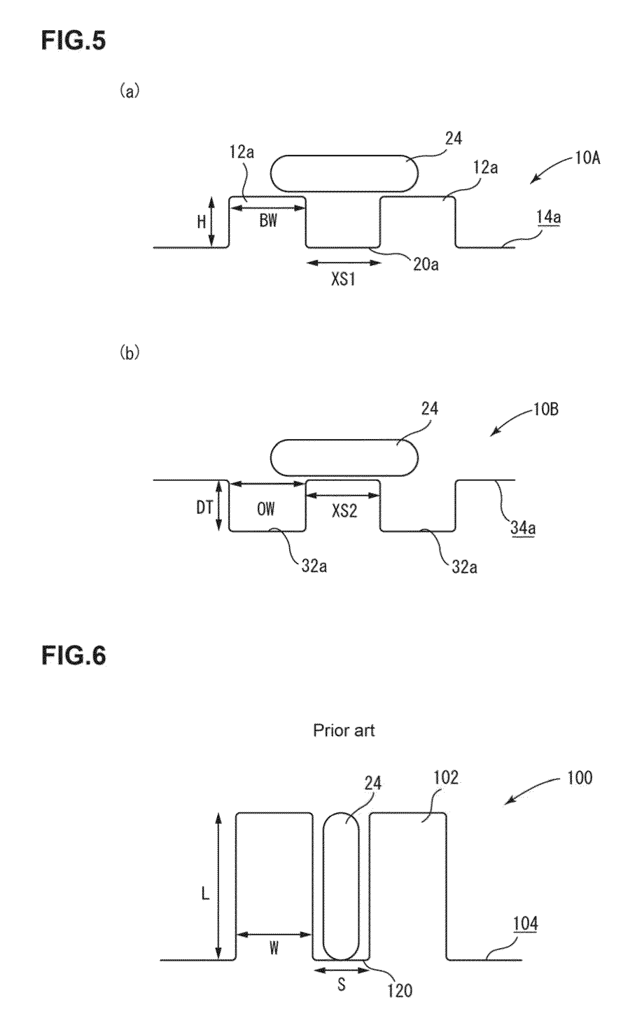

As is well illustrated in FIG. 5(a), if the height H from the surface 14a of the sheet to the top of the protrusion portion 12a is 0.4 μm to 1 μm, the bottom width BW of the protrusion portion 12a is 2 μm to 3 μm, and the width XS1 of the x-direction space 20a is equal to the bottom width BW of the protrusion portion 12a, the bacteria 24 of about 3 μm in full-length which are in static contact with the micropatterned concave and convex surface are not trapped in the x-direction spaces 20a, but the non-conductive antibacterial sheet exhibits antibacterial effect without trapping of the bacteria in the x-direction spaces 20a.

The illustrated example shows an example wherein polyacrylate is used as the acrylic resin forming the micropatterned concave and convex surface 18a, a film made of PET (polyethylene terephthalate) is used as a seat body 26 of the sheet, and the surface 14a of the sheet is produced by forming the micropatterned concave and convex surface 18a on the sheet body 26. Further, in the present invention, the acrylic resin and the sheet body 26 are non-conductive.

Then, FIG. 2 shows one example according to the second embodiment of the non-conductive antibacterial sheet of the present invention. Referring to FIG. 2, reference symbol 10B represents one example according to the second embodiment of the non-conductive antibacterial sheet of the present invention. The non-conductive antibacterial sheet 10B comprises a micropatterned concave and convex surface 38a of an acrylic resin in which there are produced micropattern concave and convex groups 36a by forming multiple groove portions 32a on the surface 34a of the sheet each having a nearly rectangular shape in a plane view. The groove portions 32a are regularly formed in an x-direction and a y-direction orthogonal thereto with x-direction spaces 40a and y-direction spaces 42a, the both spaces having predetermined widths. As is well illustrated in FIG. 2, the x-direction space 40a is a space formed in the x-direction and the y-direction space 42a is a space formed in the y-direction.

Further, a depth from the surface 34a of the sheet to the bottom of the groove portion 32a is 0.4 μm to 1 μm, an opening width of the groove portion 32a is 2 μm to 3 μm, and the width of the x-direction space 40a is equal to the opening width of the groove portion 32a.

As is well illustrated in FIG. 5(b), if the depth DT from the surface 34a of the sheet to the bottom of the groove portion 32a is 0.4 μm to 1 μm, an opening width OW of the groove portion 32a is 2 μm to 3 μm, and the width XS2 of the x-direction space 40a is equal to the opening width OW of the groove portion 32a, the bacteria 24 which are about 3 μm in full-length and are in static contact with the micropatterned concave and convex surface 38a are not trapped in the groove portions 32a, but the non-conductive antibacterial sheet exhibits antibacterial effect without trapping of the bacteria in the groove portions 32a.

The illustrated example shows an example wherein polyacrylate is used as the acrylic resin forming the micropatterned concave and convex surface 38a, a film made of PET (polyethylene terephthalate) is used as a seat body 26 of the sheet, and the surface 34a of the sheet is produced by forming the micropatterned concave and convex surface 38a on the sheet body 26. Further, in the present invention, the acrylic resin and the sheet body 26 are non-conductive.

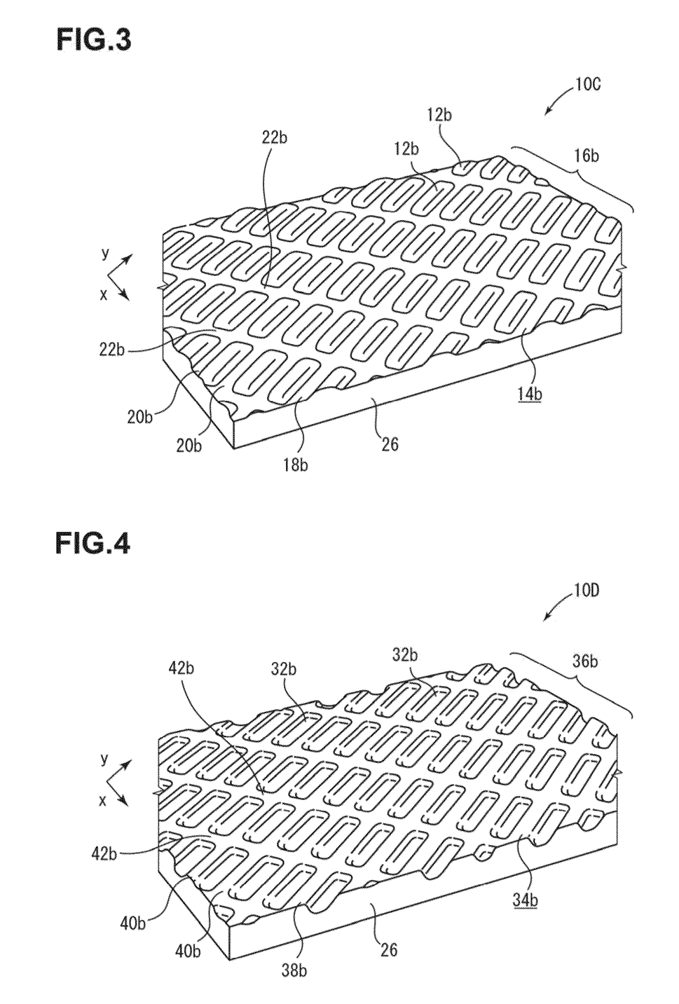

Further, FIG. 3 shows another example according to the first embodiment of the non-conductive antibacterial sheet of the present invention. Referring to FIG. 3, reference symbol 10C represents another example according to the first embodiment of the non-conductive antibacterial sheet of the present invention. The non-conductive antibacterial sheet 10C comprises a micropatterned concave and convex surface 18b of an acrylic resin in which there are produced micropattern concave and convex groups 16b by forming on the surface 14b of the sheet multiple protrusion portions 12b each having a nearly rectangular shape in a plane view. The protrusion portions 12b are regularly formed in an x-direction and a y-direction orthogonal thereto with x-direction spaces 20b and y-direction spaces 22b, the both spaces having predetermined widths. As is well illustrated in FIG. 3, the x-direction spaces 20a is a space formed in the x-direction and the y-direction spaces 22a is a space formed in the y-direction.

Further, a height from the surface 14b of the sheet to the top of the protrusion portion 12b is 0.4 μm to 1 μm, a bottom width of the protrusion portion 12b is 2 μm to 3 μm, and the width of the x-direction space 20b is equal to the bottom width of the protrusion portion 12b. The non-conductive antibacterial sheet 10C exhibits an antibacterial effect in such a way that bacteria which are in static contact with the micropatterned surface are not trapped in the x-direction spaces 20b.

In the illustrated example, there is shown an example wherein polyacrylate is used as the acrylic resin forming the micropatterned concave and convex surface 18b, a film made of PET (polyethylene terephthalate) is used as a seat body 26 of the sheet, and the surface 14b of the sheet is produced by forming the micropatterned concave and convex surface 18b on the sheet body 26. Further, in the present invention, the acrylic resin and the sheet body 26 are non-conductive.

Furthermore, FIG. 4 shows another example according to the second embodiment of the non-conductive antibacterial sheet of the present invention. Referring to FIG. 4, reference symbol 10D represents another example according to the second embodiment of the non-conductive antibacterial sheet of the present invention. The non-conductive antibacterial sheet 10D comprises a micropatterned concave and convex surface 38b of an acrylic resin in which there are produced concave and convex micropattern groups 36b by forming multiple groove portions 32b on the surface 34b of the sheet each having a nearly rectangular shape in a plane view. The groove portions 32b are regularly formed in an x-direction and a y-direction orthogonal thereto with x-direction spaces 40b and y-direction spaces 42b, the both spaces having predetermined widths. As is well illustrated in FIG. 4, the x-direction space 40b is a space formed in the x-direction and the y-direction space 42b is a space formed in the y-direction.

Further, a depth from the surface 34b of the sheet to the bottom of the groove portion 32b is 0.4 μm to 1 μm, an opening width of the groove portion 32b is 2 μm to 3 μm, and the width of the x-direction space 40b is equal to the opening width of the groove portion 32b. The non-conductive antibacterial sheet 10D also exhibits antibacterial effect without trapping of the bacteria in the groove portions 32b.

The illustrated example shows an example wherein polyacrylate is used as the acrylic resin forming the micropatterned concave and convex surface 38b, a film made of PET (polyethylene terephthalate) is used as a seat body 26 of the sheet, and the surface 34b of the sheet is produced by forming the micropatterned concave and convex surface 38b on the sheet body 26. Further, in the present invention, the acrylic resin and the sheet body 26 are non-conductive.

The bacteria in moisture such as solution form biofilms. However, the non-conductive antibacterial sheets 10A to 10D of present invention inhibit biofilm formation of the bacteria which are in static contact with the micropatterned concave and convex surfaces 18a, 38a, 18b and 38b of the non-conductive antibacterial sheets 10A to 10D.

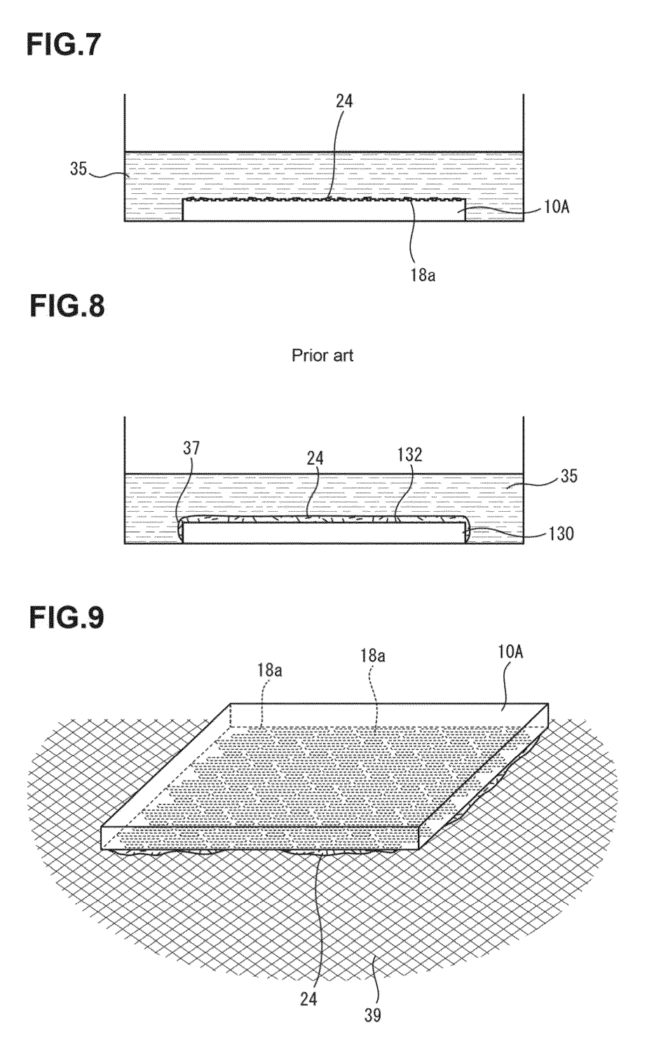

FIG. 7 schematically shows a state of inhibiting biofilm formation with the non-conductive antibacterial sheet of the present invention. As shown in FIG. 7, the non-conductive antibacterial sheet 10A inhibits formation of a biofilm 37 of the bacteria 24 which are in static contact with the micropatterned concave and convex surface 18a of the non-conductive antibacterial sheet 10A in a solution 35. For this reason, a biofilm 37 is hardly formed. In the present specification, the expression that the bacteria are in static contact with the surface means such a state that the bacteria are in contact with the surface in a quiet state without stirring or the like.

Meanwhile, as shown in FIG. 8, a conventional sheet 130 having a flat and smooth surface 132 does not inhibit biofilm formation of the bacteria 24 which are in static contact with the flat and smooth surface 132, therefore biofilm 37 is formed.

Further, swarming of the bacteria is inhibited by covering the bacteria standing still on the surface with the non-conductive antibacterial sheet of the present invention in such a way that the bacteria are in static contact with the micropatterned concave and convex surface.

FIG. 9 schematically shows a state of inhibiting swarming of the bacteria by covering the bacteria standing still on the surface with the non-conductive antibacterial sheet of the present invention in such a way that the bacteria are in static contact with the micropatterned concave and convex surface. As shown in FIG. 9, swarming of the bacteria 24 is inhibited by covering the bacteria 24 standing still on the surface 39 with the non-conductive antibacterial sheet 10A in such a way that the bacteria 24 are in static contact with the micropatterned concave and convex surface 18a of the non-conductive antibacterial sheet 10A. In the example of FIG. 9, a surface of a filter is shown as the surface 39. In the present specification, the expression of the bacteria standing still on the surface means such a state that the bacteria are standing in a quiet state without stirring or the like.

An antibacterial method of the present invention is an antibacterial method using the above mentioned non-conductive antibacterial sheet. For example, swarming of the bacteria present on the micropatterned concave and convex surface of the non-conductive antibacterial sheet and biofilm formation thereon are effectively inhibited by attaching the non-conductive antibacterial sheet of the present invention to various surfaces of a floor material, a corridor, a table, a chair, a toilet, a bathroom, etc. of buildings and facilities such as medical facilities and a nursing home, and straps and the like of a vehicle such as a train. In this way, the antimicrobial is realized.

As described above, the antibacterial method of the present invention can inhibit the biofilm formation of the bacteria by contacting the bacteria statically with the micropatterned concave and convex surface of the non-conductive antibacterial sheet.

As described above, the antibacterial method of the present invention can inhibit swarming of bacteria by covering the bacteria standing still on a surface with the non-conductive antibacterial sheet in such a way that the bacteria are in static contact with the micropatterned concave and convex surface.

Next, a method for manufacturing the non-conductive antibacterial sheet of the present invention is described. The method for manufacturing a non-conductive antibacterial sheet of the present invention comprises a step of producing the micropatterned concave and convex surface of the non-conductive antibacterial sheet by transferring an acrylic resin to a synthetic resin film with a patterning roll. And, it is preferable that the acrylic resin is an ultraviolet curable acrylic resin and the acrylic resin transferred to the synthetic resin film is cured by ultraviolet curing.

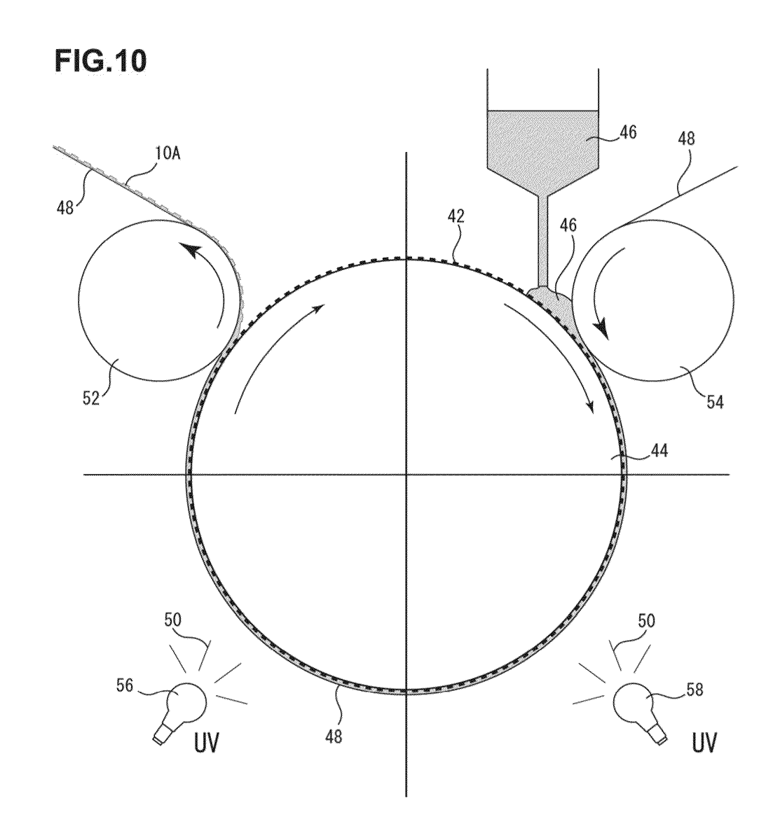

More specifically, it is possible to produce the non-conductive antibacterial sheet by using an apparatus as shown in FIG. 10. Using an apparatus as shown in FIG. 10, the method for manufacturing the non-conductive antibacterial sheet of the present invention preferably comprises steps of: supplying an ultraviolet curable acrylic resin 46 onto a surface with concave and convex micropatterns 42 of a patterning roll 44 which are produced by forming multiple protrusion portions and/or groove portions each having a nearly rectangular shape in a plane view on the surface; transferring the acrylic resin 46 to a synthetic resin film 48 by continuously conveying the synthetic resin film 48 to the surface of the patterning roll 44 so as to bring the film 48 into contact with the surface of the roll 44; and irradiating the acrylic resin 46 transferred to the synthetic resin film 48 with ultraviolet rays 58 to ultraviolet cure the acrylic resin 46.

As the synthetic resin film 48, for example, a PET film can be applied. Further, in FIG. 10, transport rolls 52, 54 for conveying the synthetic resin film 48 are provided. Furthermore, UV irradiation devices 56, 58 for irradiating ultraviolet rays are also provided. In this way, it is possible to produce the non-conductive antibacterial sheet 10A.

### EXAMPLES

The present invention is hereinafter described in more detail with Examples, but it is needless to say that Examples are only illustrative and not intended to be interpreted in a limited way.

### <Manufacturing of Patterning Rolls>

A plate base material (aluminum hollow roll) having a circumference of 600 mm and a length of 1,100 mm was prepared. New-FX (an automatic laser gravure plate making roll manufacturing equipment manufactured by THINK LABORATORY Co., Ltd.) was used to manufacture of patterning rolls. First, the plate base material (aluminum hollow roll) was placed in a copper plating bath, and the entire hollow roll was immersed in a plating solution to form a copper plating layer of 40 μm at 20 A/dm² and 6.0 V. No rashes and pits were formed on the plated surface, and a uniform copper plating layer was obtained. The surface of the copper plating layer was polished by a two-heads polisher (a polisher manufactured by THINK LABORATORY Co., Ltd.) to cause the surface of the copper plating layer to be a uniform polished surface. The above-mentioned formed copper plating layer was used as the base material, and a photosensitive film (thermal resist: TSER-NS (manufactured by THINK LABORATORY Co., Ltd.)) was applied onto the surface thereof (by a fountain coater), and drying was carried out. The thickness of the obtained photosensitive film measured by a film thickness gauge (F20 manufactured by Fillmetrics, Inc. and marketed by Matsushita Techno Trading Co., Ltd.) was 7 μm. Then, laser exposure was carried out and the image was developed. With regard to the above-mentioned laser exposure, Laser Stream FX was used and predetermined pattern exposure was carried out with the exposure condition of 300 mJ/cm². Further, with regard to the above mentioned development, a TLD developer (a developer manufactured by THINK LABORATORY Co., Ltd.) was used with the developer dilution ratio of (undiluted solution: water=1:7) and the development was carried out at 24° C. for 90 seconds to form a predetermined resist pattern portion and non-resist pattern portion.

Next, the copper plating layer of the non-resist pattern portion was etched by spraying an etching solution of cupric chloride for 20 seconds, and etching groove portions of 0.4 μm in the etching depth are formed. Then, photoresist of the resist pattern portion was separated and removed with 5% of KOH solution.

Then, the plate base material was placed in a nickel plating bath, and was halfway immersed in a plating solution to form a nickel plating layer of 1 μm at 2 A/dm² and 7.0 V. No rashes and pits were formed on the plated surface, and a uniform nickel plating layer was obtained.

A DLC coating film was formed by CVD method on the surfaces of the nickel plating layer. The DLC coating film was formed to have a thickness of 1 μm in an atmosphere of argon/hydrogen gas using toluene as a material gas at a film formation temperature of 80 to 120° C. for a film formation time period of 180 minutes.

As described above, four types of patterning rolls comprising a micropatterned concave and convex surface were manufactured, respectively. Incidentally, the production example described above was an example of forming the DLC coating film as a hard coating film, but any hard coating film such as chromium or nickel can be applied.

In observing the surface of the four types of patterning rolls with an optical microscope, the surface of the patterning rolls that forming multiple protrusion portions and/or groove portions each exhibiting a nearly rectangular shape in a plane view were observed.

Further, the above example was an example of forming the etching groove portions by etching after the development, but in the case of forming a micropattern forming the protrusion portions of 1 μm in height or the groove portions of 1 μm in depth, for example, it is preferable to form the micropattern forming the protrusion portions of 1 μm in height or the groove portions of 1 μm in depth by coating the resist pattern portion and the non-resist pattern portion with a hard coating film such as DLC without etching after the development.

### <Manufacturing of Non-Conductive Antibacterial Sheets>

Next, in the same manner as in FIG. 10, an ultraviolet curable acrylic resin was supplied onto the surfaces of the patterning rolls, the acrylic resin was transferred to a PET film as a synthetic resin film by continuously conveying and contacting the PET film to the surfaces of the patterning rolls. And, the acrylic resin transferred to the PET film was irradiated with ultraviolet rays to ultraviolet cure the acrylic resin, thereby four types of non-conductive antibacterial sheets comprising the micropatterned concave and convex surfaces as shown in FIGS. 1 to 4 ware manufactured.

### <Materials and Methods>

### [Micropatterned Concave and Convex Surfaces of the Non-Conductive Antibacterial Sheets]

For Examples 1 to 4, topographical polyacrylate plates manufactured as described above and having the four types of the micropatterned concave and convex surfaces such as the following, were used as the non-conductive antibacterial sheet. Further, for comparative example 1, a polyacrylate plates having a flat and smooth surface and prepared by applying the acrylic resin to the PET film followed by UV curing only, was used.

### Example 1

The micropatterned concave and convex surface of the polyacrylate plate was the micropatterned concave and convex surface regularly formed multiple protrusion portions with different lengths, the multiple protrusion portions each exhibiting a nearly rectangular shape in a plane view, as shown in FIG. 1. The height of the top of the protrusion portion from the surface of the sheet was 0.4 μm, the bottom width of the protrusion portion was 2 μm, the width of x-direction space was 2 μm, and the width of y-direction space was 4 μm.

### Example 2

The micropatterned concave and convex surface of the polyacrylate plate was the micropatterned concave and convex surface regularly formed multiple groove portions with different lengths, the multiple groove portions each exhibiting a nearly rectangular shape in a plane view, as shown in FIG. 2. The depth to the bottom of the groove portion from the surface of the sheet was 0.4 μm, the opening width of the groove portion was 2 μm, the width of x-direction space was 2 μm and the width of y-direction space was 4 μm.

### Example 3

The micropatterned concave and convex surface of the polyacrylate plate was the micropatterned concave and convex surface regularly formed multiple protrusion portions of 16 μm in length, the multiple protrusion portions each exhibiting a nearly rectangular shape in a plane view, as shown in FIG. 3. The height of the top of the protrusion portion from the surface of the sheet was 0.4 μm, the bottom width of the protrusion portion was 2 μm, the width of x-direction space was 2 μm, and the width of y-direction space was 6 μm.

### Example 4

The micropatterned concave and convex surface of the polyacrylate plate was the concave and convex micropatterned surface regularly formed multiple groove portions of 16 μm in length, the multiple groove portions each exhibiting nearly rectangular shape in a plane view, as shown in FIG. 4. The depth to the bottom of the groove portion from the surface of the sheet was 0.4 μm, the opening width of the groove portion was 2 μm, the width of x-direction space was 2 μm and the width of y-direction space was 6 μm.

### [Bacterial Strains and Culture Conditions]

Pseudomonas aeruginosa (approximately 10⁸ cells/ml) was cultured in 5 ml of a glucose (0.4%) minimal VBMM medium (Non-Patent Document 9) at 37° C. with stirring at 120 rpm in L-type glass tube (1.5 cm diameter, 13.5 cm horizontal length, and 8 cm height) according to the method of Hassett et al. (Non-Patent Document 10). Bacterial cell growth of pseudomonas aeruginosa was monitored by measuring absorbance at 540 nm. In order to adjust the ratio of areas of plates to the volume of the medium, 25 pieces of polyacrylate plates (1 cm×2 cm) with different surface shapes were added to L-type glass tube.

### [Measurement of Static Biofilm Formation]

A microtiter static biofilm assay was performed in accordance with the method described in Non-Patent Document 11. A culture solution in which bacterial cells were cultured overnight were diluted 1:1000 in a VBMM medium so as to yield an initial absorbance (A540) of 0.01 to 0.02 (approximately 10⁶ cells/ml). The diluted culture solution (50 μl) was incubated in a 96-well microtiter plate at 37° C. for 24 h without stirring, and the bacterial cell density was determined by measuring at the absorbance of A595. After planktonic bacterial cells were removed, the obtained biofilm was stained with 0.1% crystal violet solution (0.2 ml) at room temperature for 30 min, and washed 5 times in distilled water. Crystal violet stain was solubilized in 20% acetic acid (0.2 ml), and the absorbance at 570 nm was measured. Biofilm formation was expressed at A570/A595. Polyacrylate plates (6 mm diameter) having different surface shapes were set on each well such that bacteria are in static contact with micropatterned concave and convex surfaces of the plates.

### [Swarming Motility Assays]

Swarming motility experiments were performed according to the method of de la Fuente-Nunez et al. (Non-Patent Document 12). Bacterial cells cultured overnight were diluted in VBMM medium to the state that the absorbance (A540) reaches to 0.05. 5 μl of the diluted bacterial cells were spotted onto the center of 0.5% agar plates containing Luria-Bertani (LB) medium, and covered with polyacrylate plates (1 cm×1 cm) with different surface shapes. Agar plates were incubated at 37° C. for 24 h. Photographs were taken and the swarming areas were measured.

### [Scanning Electron Microscopy (SEM)]

Observation by SEM was performed in according with the method described in Lamppa and Grieswold (Non-Patent Document 13). Cells were cultured as described in the section of “Swarming motility assays”, and polyacrylate plates were fixed with 2% glutaraldehyde at 4° C. overnight. Dehydration of the plates were performed in 50%, 70%, 80%, 90% and 95% acetone for 15 min each, and in 100% acetone and 100% tertiary butyl alcohol for 15 min with 3 times each. The plates were then air dried with the vacuum evaporator (JFD-310, JEOL, Japan) for 3 hours, and mounted on SEM stubs with a melted apiezon wax layer. The mounted plates were then sputter coated with gold and palladium and observed by SEM (JSM-6060LV, JEOL, Japan).

### <Result>

### [Decrease in Biofilm Formation on the Non-Conductive Antibacterial Sheet]

In order to study whether non-conductive antibacterial sheet itself is important to decrease biofilm formation of Pseudomonas aeruginosa, bacterial cell growth and biofilm formation of P. aeruginosa were compared with the flat and smooth plate of Comparative example 1 and the plates having a micropatterned concave and convex surface of Examples 1 to 4.

### EXPERIMENTAL EXAMPLES

—Culture Experiments with Stirring—

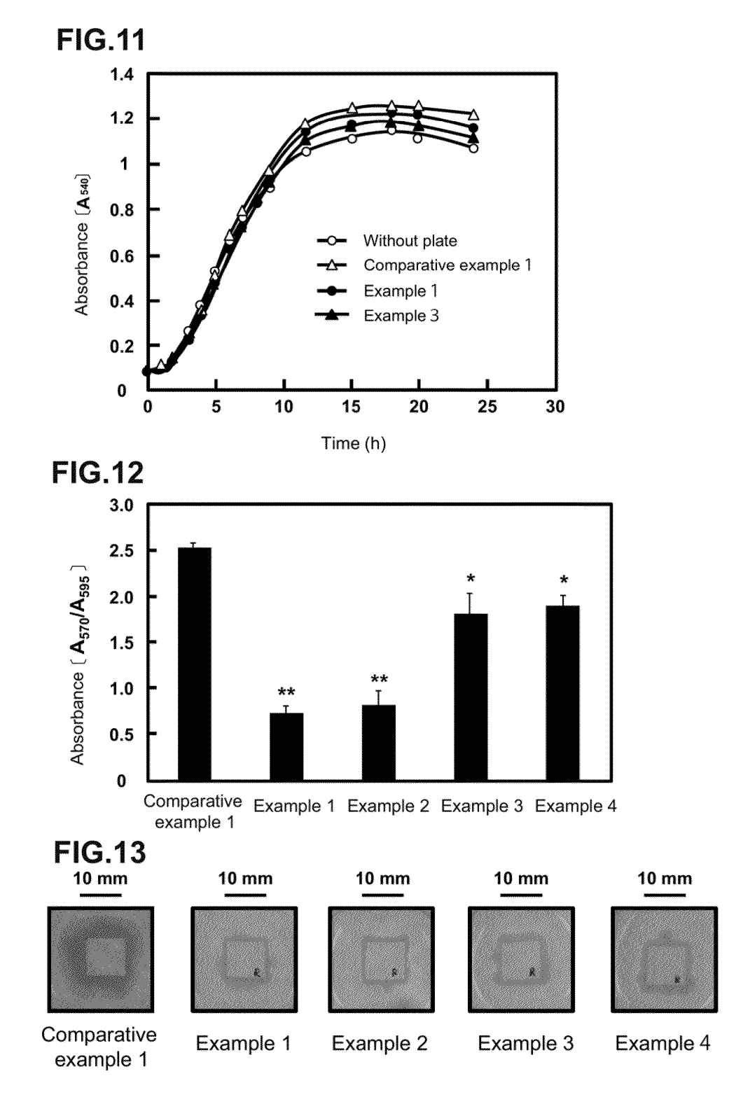

Bacterial cells were cultured with stirring in 5 ml of glucose minimal VBMM medium containing 25 pieces of various plates (1 cm×2 cm) of Examples 1, 3 and Comparative example 1. For comparison, bacterial cells were also cultured without plates. FIG. 11 shows effect of various types of micropatterned plates on cell growth of Pseudomonas aeruginosa with stirring. Cell growth was observed by measuring absorbance [A₅₄₉] in the presence of various types of plates. As shown in FIG. 11, cell growth of P. aeruginosa was not inhibited with any kinds of plates when bacterial cells were cultured with stirring.

### Examples 1 to 4 and Comparative Example 1

—Experiments with Standing Still—

A microtiter static biofilm assay was performed by placing various plates of Examples 1 to 4 and Comparative example 1 on each well such that bacteria are in static contact with micropatterned concave and convex surfaces of the plates. In contrast to cell growth with stirring, biofilm formation on the plates was greatly inhibited when the topographical plates having the micropatterned surfaces of Examples 1 to 4 were used instead of the flat and smooth plate (Comparative example 1). The degree of inhibition of biofilm formation by the topographical plates having the micropatterned concave and convex surfaces of Examples 1 to 4 was approximately 70%. If the topographical plates having the micropatterned concave and convex surfaces of Examples 3 and 4 were used, biofilm formation was also inhibited. The degree of inhibition of biofilm formation by the plates of Examples 3 and 4 was approximately 30%. In decrease in the biofilm formation, inhibitory effects against the biofilm formation of the convex type of plates having the protrusion portions (Examples 1 and 3) were almost the same as the concave type of plates having the groove portions (Examples 2 and 4). The results are shown in FIG. 12. FIG. 12 shows the biofilm formation of Pseudomonas aeruginosa after the culture on the various types of plates without stirring. The biofilm formation was estimated as described in the above-mentioned [materials and methods]. Student's t test was performed for the values obtained in the presence of the topography plates having a micropatterned concave and convex surfaces of Examples 1 to 4 versus the values obtained in the presence of the flat and smooth plate of Comparative example 1. In FIG. 12, the marks * and ** mean p<0.05; ** p<0.01.

### [Decrease in Swarming Motility of Cells on the Non-Conductive Antibacterial Sheet]

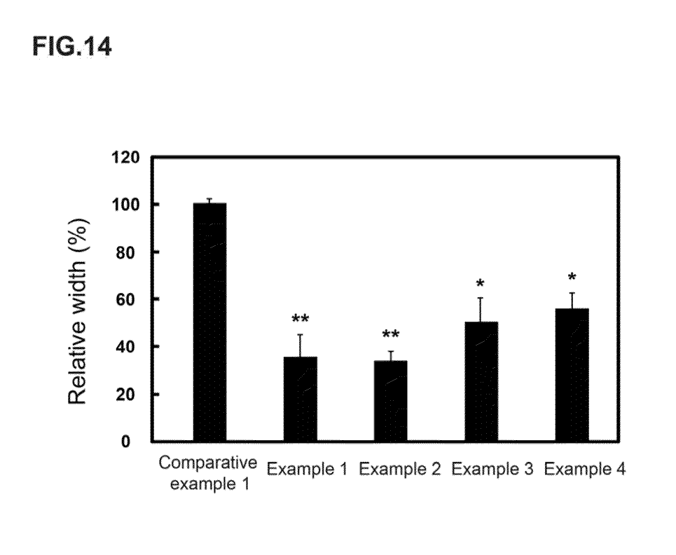

Then there was tested whether swarming motility of P. aeruginosa is also inhibited by the non-conductive antibacterial sheet because swarming of bacterial cells is one of the important factors for bacterial infections. Diluted cells were spotted on soft agar, covered with various plates of Examples 1 to 4 and Comparative example 1 in a state of putting on the bacteria standing still on the agar surface, and incubated at 37° C. for 24 hours in these conditions. FIGS. 13 and 14 show swarming of Pseudomonas aeruginosa on 0.5% agar plates covered with the various types of plates. Swarming of the cells was estimated as described in the above-mentioned [materials and methods]. FIG. 13 shows pictures of swarming of the cells. FIG. 14 is a graph showing relative widths of swarming areas of the cells covered with the topography plates having the micropatterned concave and convex surfaces of Examples 1 to 4 as the percentages in comparison with the cells covered with the flat and smooth plate of Comparative example 1. Student's t test was performed for the values obtained in the presence of the topography plates having a micropatterned concave and convex surfaces of Examples 1 to 4 versus the values obtained in the presence of the flat and smooth plate of Comparative example 1. In FIG. 14, the marks * and ** mean p<0.05; ** p<0.01.

As shown in FIGS. 13 and 14, swarming of the cells was strongly inhibited with the topographical plates having the micropatterned concave and convex surfaces of Examples 1 and 2, and it was weakly inhibited with the topographical plates having the micropatterned concave and convex surface of Examples 3 and 4. The degrees of inhibition of swarming of the bacterial cells by the plates of Examples 1 and 2 and the plates of Examples 3 and 4 were approximately 65% and 50%, respectively, compared to swarming of the bacterial cells covered by the flat and smooth plate of Comparative example 1. The above degree of inhibition of swarming of the convex type of plates having the protrusion portions (Examples 1 and 3) were almost the same as the concave type of plates having the groove portions (Examples 2 and 4). The results indicate that swarming of the bacterial cells was also inhibited by the topographical plates having the micropatterned concave and convex surfaces used in Examples 1 to 4.

### [Decrease in Cell Number of Bacteria on the Plates]

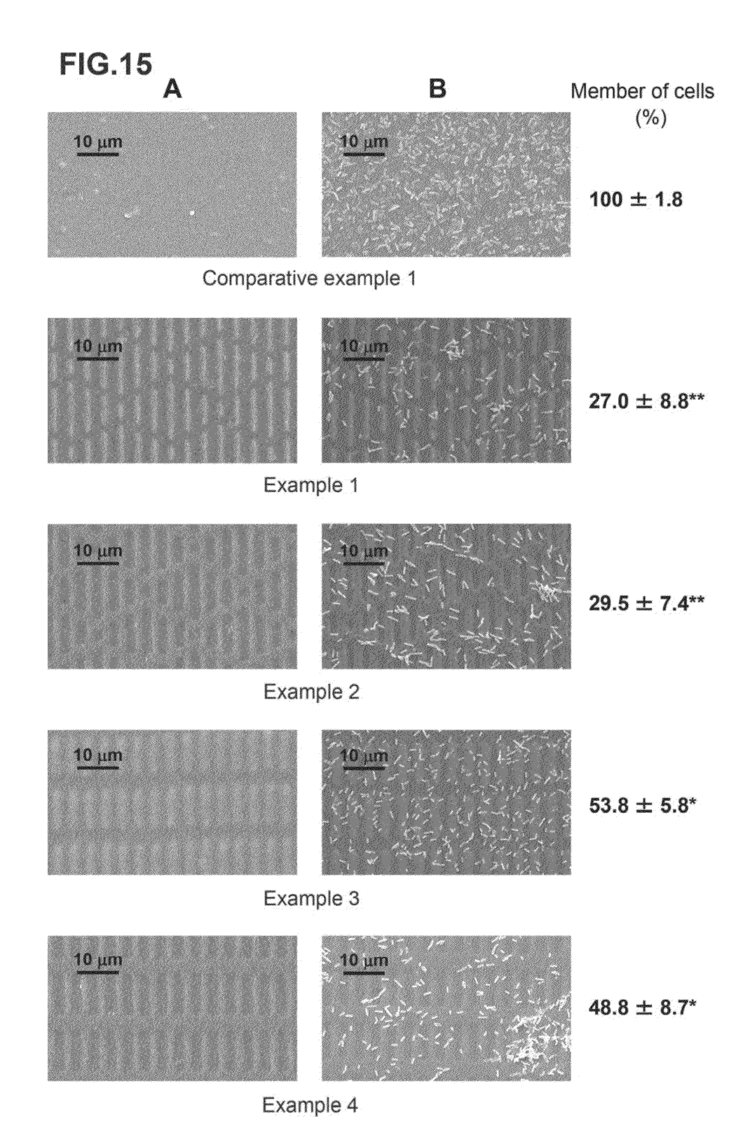

The state of the bacterial cells on the various plates of Examples 1 to 4 and Comparative example 1 used for the above-mentioned swarming motility assay was analyzed in more detail by scanning electron microscopy (SEM) (FIG. 15). Micropatterned topographies of the surfaces of the various plates were shown in FIG. 15A. FIG. 15 shows results of the measurement of the cell number of Pseudomonas aeruginosa after the culture on the various types of plates without stirring, FIG. 15A shows SEM photographs of various types of the plates, and FIG. 15B shows SEM photographs of Pseudomonas aeruginosa on various types of the plates. The bacterial cells were cultured as described in the legends of FIGS. 13 and 14, and the cells in 10 μm² on SEM were counted in 20 different plates. The average cell numbers on various types of the plates were shown as percentages compared to the cells cultured on the flat and smooth plate. Percent of cell numbers is equal to the mean value of the standard error (mean±S. E.). Student's t test was performed for the values obtained in the presence of the topography plates having a micropatterned concave and convex surfaces of Examples 1 to 4 versus the values obtained in the presence of the flat and smooth plate of Comparative example 1. In FIG. 14, the marks * and ** mean p<0.05; ** p<0.01.

In both Example 1 and Example 2, the cell number on the plates decreased to about 30% compared to the flat and smooth plate of Comparative example 1. In both Example 3 and Example 4, the cell number on the plates decreased to about 50% compared to the flat and smooth plate of Comparative example 1. Since the feature height was short (0.4 μm), the bacterial cells were located on the top of the protrusion portions of the plate surfaces of Examples 1 and 3 and on the x-direction spaces of the plate surfaces of Examples 2 and 4, but not within the x-direction spaces of the plate surfaces of Examples 1 and 3 and groove portions of the plates of Examples 2 and 4 (FIG. 15B). As in Examples 1 to 4, the location of the bacterial cells in the topographical plate having a shallow concave and convex (0.4 μm) surface was in contrast with the location of the bacterial cells in the topographical plate having a deep concave and convex (3 μm) surface such as a conventional micropattern of Sharklet (registered trademark). These results indicate that the non-conductive antibacterial sheet of the present invention itself is involved in the decrease in cell number of the bacteria and the biofilm formation, even a shallow concave and convex surface.

### [Discussion]

It has been reported that the shark skin topography plate (Sharklet (registered trademark)) (2 μm feature width and spacing, 3 μm feature height) consisting of silicon elastomer inhibited biofilm formation and swarming of Staphylococcus aureus (Non-Patent Document 7) and Escherichia coli (Non-Patent Document 8). This plate also inhibited the attachment of Ulva linza zoospores (Non-Patent Document 15).

The present inventors confirmed that the topographical plate having the micropatterned surface with shallow feature height (2 μm feature width and spacing, 0.4 μm feature height) consisting of polyacrylate also inhibited biofilm formation of Pseudomonas aeruginosa. According to the non-conductive antibacterial sheet of the present invention, inhibition of biofilm formation was also observed with Escherichia coli (data not shown). Further, according to the non-conductive antibacterial sheet of the present invention, inhibition of biofilm formation was also observed with Staphylococcus aureus (data not shown). Thus, the above effects in both Gram-negative bacteria and Gram-positive bacteria were confirmed. It is considered that there are several factors involved in the decrease in biofilm formation and swarming motility.

The above factors are surface properties, surface topography, feature dimension, and tortuosity. The results suggest that tortuosity due to the variety of surface topography on the plate is important for the decrease in biofilm formation and swarming motility. This idea was also supported from the results that similar antibacterial effects were obtained using the plate having a surface shape with protrusion portions such as in Examples 1 and 3 and the plate having a surface shape with groove portions such as in Examples 2 and 4.

Further, the degree of inhibition by the non-conductive antibacterial sheet of the present invention as for the biofilm formation and the swarming motility was increased when the cell number at the starting point was small. According to the non-conductive antibacterial sheet of the present invention, it is possible to remove bacteria almost completely when the cell number of contaminated bacteria is less than 1×10⁴ cells/cm². Considering the results in a comprehensive way, those show the fact that bacterial infections could be greatly decreased if building and instruments would be covered with the non-conductive antibacterial sheet of the present invention in the facilities involved in medical treatments, or in places where people assemble.

### REFERENCE SIGNS LIST

10A, 10B, 10C, 10D: non-conductive antibacterial sheet of the present invention, 12a, 12b: protrusion portion, 14a, 14b, 34a, 34b: surface of sheet, 16a, 16b, 36a, 36b: micropattern concave and convex group, 18a, 18b, 38a, 38b: micropatterned concave and convex surface, 20a, 20b, 40a, 40b: x-direction space, 22a, 22b, 42a, 42b: y-direction space, 24: bacteria, 26: seat body, 32a, 32b: groove portion, 35: solution, 37: biofilm, 39: surface, 42: concave and convex micropattern, 44: patterning roll, 46: acrylic resin, 48: synthetic resin film, 50: ultraviolet ray, 52, 54: transport roll, 56, 58: UV irradiation device, 100: conventional conductive antibacterial sheet, 104: surface of conventional sheet, 102: protrusion portion of conventional sheet, 120: space of groove portion of conventional sheet, 130: conventional sheet having flat surface, 132: flat surface, BW: bottom width of protrusion portion, DT: depth to bottom of groove portion from surface of sheet, H: height of top of protrusion portions from surface of sheet, L: height of top of protrusion portions from surface of conventional sheet, OW: opening width of groove portion, S: width of space of groove portion of conventional sheet, W: bottom width of protrusion portion of conventional sheet, XS1, XS2: width of x-direction space.

1. A non-conductive antibacterial sheet comprising a micropatterned concave and convex surface of an acrylic resin in which there are produced concave and convex micropattern groups by forming on the surface of the sheet multiple protrusion portions each having a nearly rectangular shape in a plane view,
wherein the protrusion portions are regularly formed in an x-direction and a y-direction orthogonal thereto with x-direction spaces and y-direction spaces, the both spaces having predetermined widths;
a height from the surface of the sheet to the top of the protrusion portion is 0.4 μm to 1 μm;
a bottom width of the protrusion portion is 2 μm to 3 μm, and the width of the x-direction space is equal to the bottom width of the protrusion portion; and
the non-conductive antibacterial sheet exhibits an antibacterial effect in such a way that bacteria which are in static contact with the micropatterned surface are not trapped in the x-direction spaces.

2. A non-conductive antibacterial sheet comprising a micropatterned concave and convex surface of an acrylic resin in which there are produced concave and convex micropattern groups by forming on the surface of the sheet multiple groove portions each having a nearly rectangular shape in a plane view,
wherein the groove portions are regularly formed in an x-direction and a y-direction orthogonal thereto with x-direction spaces and y-direction spaces, the both spaces having predetermined widths;
a depth from the surface of the sheet to the bottom of the groove portion is 0.4 μm to 1 μm;
an opening width of the groove portion is 2 μm to 3 μm, and the width of the x-direction space is equal to the opening width of the groove portion; and
the non-conductive antibacterial sheet exhibits an antibacterial effect in such a way that bacteria which are in static contact with the micropatterned surface are not trapped in the groove portions.

3. A non-conductive antibacterial sheet according to claim 1, wherein biofilm formation of the bacteria which are in static contact with the micropatterned surface of the non-conductive antibacterial sheet is inhibited.

4. A non-conductive antibacterial sheet according to claim 1, wherein swarming of bacteria is inhibited by covering the bacteria standing still on a surface with the non-conductive antibacterial sheet in such a way that the bacteria are in static contact with the micropatterned surface.

5. A non-conductive antibacterial sheet according to claim 4, wherein the surface on which the bacteria stand still is a surface of a filter.

6. An antibacterial method comprising the use of the non-conductive antibacterial sheet according to claim 1.

7. An antibacterial method wherein biofilm formation of bacteria is inhibited by contacting the bacteria statically with the micropatterned concave and convex surface of the non-conductive antibacterial sheet according to claim 1.

8. An antibacterial method wherein swarming of bacteria is inhibited by covering the bacteria standing still on a surface with the non-conductive antibacterial sheet according to claim 1.

9. A method for manufacturing the non-conductive antibacterial sheet according to claim 1, wherein the micropatterned concave and convex surface of the non-conductive antibacterial sheet is produced by transferring an acrylic resin to a synthetic resin film with a patterning roll.

10. A method for manufacturing the non-conductive antibacterial sheet according to claim 9, wherein the acrylic resin is an ultraviolet curable acrylic resin, and the acrylic resin transferred to the synthetic resin film is cured by ultraviolet curing.

11. A method for manufacturing a non-conductive antibacterial sheet according to claim 1, comprising steps of:
supplying an ultraviolet curable acrylic resin onto a surface with concave and convex micropatterns of a patterning roll which are produced by forming multiple protrusion portions and/or groove portions each having a nearly rectangular shape in a plane view on the surface;
transferring the acrylic resin to a synthetic resin film by continuously conveying the synthetic resin film to the surface of the patterning roll so as to bring the film into contact with the surface of the roll; and
irradiating the acrylic resin transferred to the synthetic resin film with ultraviolet rays to cure the acrylic resin.
